(19) United States
(12) Patent Application Publication
(10) Pub. No.: US 2021/0252946 A1
(43) Pub. Date: Aug. 19, 2021

(54) ELECTRIC POWERED REAR-MOUNTED TRANSPORTATION REFRIGERATION UNIT

(71) Applicant: Carrier Corporation, Palm Beach Gardens, FL (US)

(72) Inventor: Mary D. Saroka, Palm Beach Gardens, FL (US)

(21) Appl. No.: 17/251,257

(22) PCT Filed: Nov. 11, 2019
(86) PCT No.: PCT/US2019/060693

§ 371 Date: Dec. 11, 2020

Related U.S. Application Data
(60) Provisional application No. 62/768,288, filed on Nov. 16, 2018.

(51) Int. Cl. B60H 1/32; B60P 3/20

(52) U.S. Cl. CPC B60H 1/3232; B60H 1/00014; B60P 3/20

(57) ABSTRACT

A split trailer refrigeration unit for a tractor trailer includes a first portion (140A) having an electrically driven compressor (230), a condenser (210) and an evaporator (220). Also included is a second portion (140B), having an electrically driven compressor, a condenser and an evaporator. At least one of the first portion and the second portion include a set of power electronics (242) and a battery (240) connecting an electricity source to the corresponding electric compressor. The set of power electronics is configured to control power characteristics of power provided from the electricity source to the electric compressor. A frame (142) is configured to structurally mount each of the first portion and the second portion to a rear trailer door.

### CROSS-REFERENCE TO RELATED APPLICATIONS

This application claims priority to U.S. Provisional Application No. 62/768,288, which was filed on Nov. 16, 2018 and is incorporated herein by reference.

### TECHNICAL FIELD

The present disclosure relates generally to transportation refrigeration units, and more specifically to a rear mounted electric powered transportation refrigeration unit for tractor trailers.

### BACKGROUND

Tractor trailers for carrying refrigerated goods typically include a refrigeration unit mounted to the front of the trailer and positioned between the tractor and the trailer. The refrigeration units typically include a diesel, or other fossil fuel, powered generator that provides operational power to the refrigeration unit, allowing the trailer to be maintained at a cool or cold temperature.

Recent tractor trailer constructions have redesigned the tractors and/or the trailers in order to reduce drag on the vehicle and increase the efficiency of the vehicle. The redesigns include features such as fairings extending from the rear sides, top, or both of the tractor toward the front of the trailer, and a reduction in the length of the gap between the tractor and the trailer and the use of boat tail extensions from the rear of the trailer.

### SUMMARY OF THE INVENTION

In one exemplary embodiment a split trailer refrigeration unit for a tractor trailer includes a first portion including an electrically driven compressor, a condenser and an evaporator, a second portion, the second portion including an electrically driven compressor, a condenser and an evaporator, at least one of the first portion and the second portion including a set of power electronics connecting an electricity source to the corresponding electric compressor, the set of power electronics being configured to control power characteristics of power provided from the electricity source to the electric compressor, and a frame configured to structurally mount each of the first portion and the second portion to a rear trailer door.

In another example of the above described split trailer refrigeration unit for a tractor trailer the electricity source is at least one of an electrical storage unit and a power interface connected to an external power source.

In another example of any of the above described split trailer refrigeration units for a tractor trailer the electricity source includes both the electrical storage unit and the power interface connected to the external power source.

In another example of any of the above described split trailer refrigeration units for a tractor trailer the frame is integral to a trailer door and wherein a trailer door latch is a component of the frame.

In another example of any of the above described split trailer refrigeration units for a tractor trailer the frame is mountable to a trailer door and distinct from the trailer door.

In another example of any of the above described split trailer refrigeration units for a tractor trailer each of the first portion and the second portion is sized to independently refrigerate a trailer.

Another example of any of the above described split trailer refrigeration units for a tractor trailer further includes a controller configured to operate the first portion in an electrical storage unit charging operation and the second portion in a refrigeration operation during a first mode, and configured to operate the second portion in the electrical storage unit charging operation and the first portion in the refrigeration operation during a second mode.

In another example of any of the above described split trailer refrigeration units for a tractor trailer the controller is configured to transition from the first mode to the second mode in response to the electrical storage unit in the second portion falling below a charge threshold.

In another example of any of the above described split trailer refrigeration units for a tractor trailer each of the first and second portion are sized to provide less than full refrigeration of the trailer.

Another example of any of the above described split trailer refrigeration units for a tractor trailer further includes an external skin covering at least one of the first portion and the second portion.

In another example of any of the above described split trailer refrigeration units for a tractor trailer the external skin comprises a first aerodynamic component covering the first portion and a second aerodynamic component covering the second portion.

In another example of any of the above described split trailer refrigeration units for a tractor trailer the external skin has an aerodynamic profile including one of an angular planar configuration, hemispherical curved configuration and a teardrop configuration.

An exemplary method for refrigerating a tractor trailer includes powering at least one portion of a rear mounted refrigeration unit via an electrical power source and operating the at least one portion of a rear mounted refrigeration unit in a refrigeration mode.

In another example of the above described exemplary method for refrigerating a tractor trailer powering the at least one portion of the rear mounted refrigeration unit via the electrical power source comprises simultaneously powering a first portion and a second portion of the rear mounted refrigeration unit via the electrical power source, wherein each of the first portion and the second portion are substantially identical.

In another example of any of the above described exemplary methods for refrigerating a tractor trailer each of the first portion and the second portion are sized such that the first and second portion are insufficiently to independently cool the tractor trailer.

In another example of any of the above described exemplary methods for refrigerating a tractor trailer powering the at least one portion of the rear mounted refrigeration unit comprises providing power to a first portion of the at least one portion during a first mode of operations and charging an electrical storage unit of a second portion of the at least one portion during the first mode of operations.

Another example of any of the above described exemplary methods for refrigerating a tractor trailer further includes providing power to the second portion of the at least one portion during a second mode of operations and charging an electrical storage unit of the first portion of the at least one portion during the second mode of operations.

Another example of any of the above described exemplary methods for refrigerating a tractor trailer further includes transitioning from the first mode of operations to the second mode of operations, in response to an electrical storage unit in the first portion falling below a threshold charge level.

In one exemplary embodiment a tractor trailer vehicle includes a tractor including a plurality of fairings extending rearward from a rear end of the tractor, a trailer connected to the tractor, wherein a gap between the rear end of the tractor and a forward end of the trailer is less than 43 inches, and a rear mounted refrigeration unit connected to a rear end of the trailer via a frame, wherein the rear mounted refrigeration unit including a first portion including an electrically driven compressor, a condenser and an evaporator, a second portion, the second portion including an electrically driven compressor, a condenser and an evaporator, and at least one of the first portion and the second portion including a set of power electronics connecting an electricity source to the corresponding electric compressor, the set of power electronics being configured to control power characteristics of power provided from the electricity source to the electric compressor.

Another example of the above described tractor trailer vehicle further includes an aerodynamic external skin covering at least one of the first portion and the second portion.

These and other features of the present invention can be best understood from the following specification and drawings, the following of which is a brief description.

### BRIEF DESCRIPTION OF THE DRAWINGS

FIG. 1 illustrates an exemplary prior art tractor trailer configuration.

FIG. 2 schematically illustrates an exemplary embodiment of a trailer including a rear mounted electric refrigeration unit.

FIG. 3 schematically illustrates a top and rear view of the exemplary vehicle 100 of FIG. 2.

### DETAILED DESCRIPTION

FIG. 1 schematically illustrates an exemplary vehicle 10 including a tractor 20 configured to pull a trailer 30. The trailer 30 is a refrigerated trailer, and includes a refrigeration unit 40 mounted to a front end 32 of the trailer 30. The refrigeration unit 40 includes a diesel, or other fossil fuel, based power generation unit configured to provide operational power to the refrigeration unit 40. The refrigeration unit 40 refrigerates the trailer 30 during transportation of temperature sensitive goods.

Driving the vehicle 10 induces an airstream 50 that passes over the tractor 20 and the trailer 30 and causes drag on the vehicle 10. The drag, in turn, decreases the efficiency of the tractor 20 and increases fuel consumption during transportation. In order to reduce the inefficiencies associated with drag, a gap 22 between the tractor 20 and the trailer 30 is reduced in length, and aerodynamic flaps 24, referred to as fairings, are added extending from the tractor 20 toward the front of the trailer 30. However, the reduction of the gap 22 and the addition of the aerodynamic flaps 24 reduces the available space for the refrigeration unit 40 and can, in some examples, eliminate the feasibility of placing a conventional trailer refrigeration unit in the gap 22.

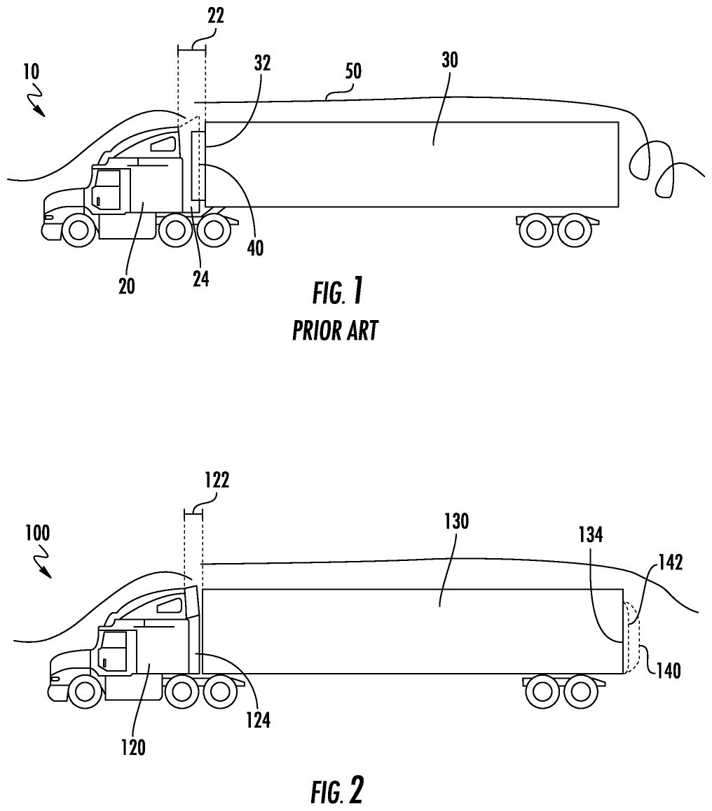

With continued reference to FIG. 1, FIG. 2 schematically illustrates an embodiment of a trailer 130 including a rear mounted refrigeration unit 140. The rear mounted refrigeration unit 140 is an electric refrigeration unit 140, and includes a battery configured to power the refrigeration systems. In alternative examples the rear mounted refrigeration unit 140 can include an electrical connection allowing the refrigeration unit 140 to connect to, and draw power from, an electric engine within the tractor 120 or any other source of electrical power on the vehicle 100. In yet further alternative examples, the rear mounted refrigeration unit 140 can include both a battery and an electrical connection to the tractor 120, with either the battery or the electrical connection operating as a backup configuration in case the primary configuration is damaged or otherwise unusable.

A frame 142 connects the refrigeration unit 140 to the rear end 134 of the trailer 130. As the refrigeration unit 140 is mounted to the rear end 134, a gap 122 between the trailer and the tractor 120 is substantially reduced relative to prior art systems, and aerodynamic flaps 124 can extend almost the entirety of the gap 122. By way of example, the gap 122 can be less than 43 inches in some configurations. In some examples, the frame 142 can be integrated with the rear doors of the trailer 130 such that a door latch is incorporated into the frame 142. In alternative examples, the frame 142 can be mounted to an existing door structure, and is configured such that the frame 142 does not interfere with the door latch system.

With continued reference to FIGS. 1 and 2, FIG. 3 schematically illustrates a top and rear view of the vehicle 100 of FIG. 2. Mounted to the rear of the vehicle 100 on doors 202 are two portions of a split refrigeration unit 140A, 140B. The portions of the split refrigeration unit 140A, 140B are mounted to the doors via the frame 142. In some examples, a latch 144 for the doors is independent of the frame 142 and the frame 142 is configured not to interfere with the door latch 144 and the opening of the door. In alternative examples, the frame 142 and the latch 144 are integrated, and the frame is built into the door structure.

Each portion of the split refrigeration unit 140A, 140B is substantial identical to the other portion. As used herein substantial identical refrigeration unit portions are portions that include the same general components in the same general layout, while allowing for minor constructional variations to accommodate a split rear door 202 structure. By way of example, the variations can include mirrored configurations, minor size differences, and the like.

Each of the rear mounted refrigeration portions in the split refrigeration unit 140A, 140B includes a condenser 210 with a condenser coil 211 and electric condenser fan 212 used to draw outside air through the condenser coil 211. The condenser coil 211 is a refrigerant heat rejection heat exchanger and is connected in refrigerant flow communication via a closed-loop circuit with the evaporator 220 (acting as a refrigerant heat absorption heat exchanger), electric compressor 230 and other components such as an expansion device, filter drier, receiver, liquid-suction heat exchanger and/or accumulator required as necessary to meeting operational needs. The evaporator 220 uses electric fan(s) to pass air drawn from the trailer cargo space via the return air input 214 which heats and evaporates the refrigerant thus cooling the air. The cooled air is then delivered to the trailer cargo space via the supply air output 216. An electric compressor 230 provides compression to the condenser 210 and evaporator 220 systems, and allows the split refrigeration unit 140A, 140B to function.

Each of the electric compressors 230, the electric condenser and the evaporator fans are electrically connected to an electrical energy storage unit 240, such as a battery, a super capacitor, or any other rechargeable electrical storage unit. In alternative examples, the electric compressor 230, the electric condenser and the evaporator fans can be connected to an interface 250, or incorporate the interface 250 within the electric compressor 230. The interface 250 allows a connection to the electrical systems of the tractor portion of the vehicle 100, and is configured to provide operational power to the split refrigeration unit 140A, 140B.

In yet further examples, the interface 250 and the electrical storage unit 240 can both be included, and power from the tractor can be used to both power the portions of the split refrigeration unit 140A, 140B, and to charge the electrical storage unit 240. Connected to the electrical storage unit 240 in the illustrated example is a set of power electronics 242. The power electronics 242 regulate the voltage and current provided from the electrical storage unit 240 or the interface 250 to the electric compressor 230, the electric condenser and the evaporator fans using any conventional power electronics configuration.

Also included in each portion of the split refrigeration unit 140A, 140B is a control box 260 which includes a controller 261, contactors, relays, fuses, and the like. The controller 261 is controllably coupled to each of the controlled elements of the refrigeration unit 140A, 140B, and provides the operational parameters and controls to the corresponding split refrigeration unit 140A, 140B. In alternative examples, a single controller 261 can be included in one of the portions of the split refrigeration unit 140A, 140B and provide controls to the components of both portions of the split refrigeration unit 140A, 140B. In such a configuration, the controller 261 would include a connection configured to be easily coupled and decoupled such that a driver, or other vehicle operator, could decouple the controller connection prior to opening the doors, and recouple the controller 261 upon closing the doors.

In yet further alternative examples, each portion of the split refrigeration unit 140A, 140B can include a corresponding controller 261, with the controllers 261 being interfaced together such that one of the controllers 261 can take control of the other portions of the split refrigeration unit 140A, 140B in the event that the other controller 261 fails. As with the single controller 261 example described above, this alternative would include a communication cable connecting the controllers 261 and being configured to easily disconnect and reconnect when the driver or operator of the vehciloe opens and closes the doors.

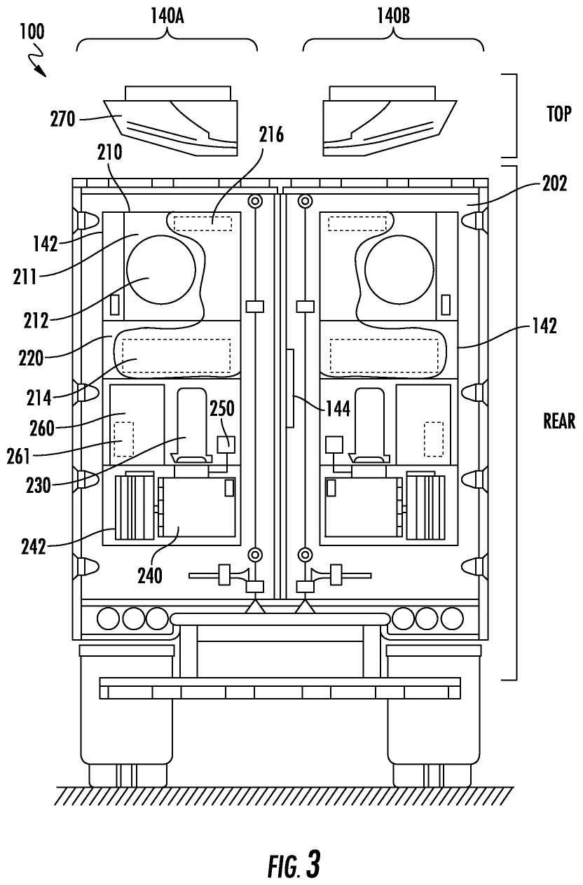

Referring now to the top view portion of FIG. 3, each of the split refrigeration unit 140A, 140B is covered via a skin 270. The skin 270 encloses the components of the split refrigeration unit 140A, 140B and protects the split refrigeration unit 140A, 140B from environmental hazards such as road salt, mud, debris, as well as from environmental conditions like rain or snow. In addition to the protection provided, the skin 270 includes an aerodynamic profile that assists in reducing drag on the vehicle 100 during transportation. In some examples, the aerodynamic profile can be an angled planar shape. In other examples, the aerodynamic profile can include a hemispherical curved or teardrop shape encompassing the corresponding split refrigeration unit 140A, 140B components. In yet further examples, a hybrid of the angled planar shape and the teardrop shape can be utilized.

In the illustrated example, each of the portions of the split refrigeration unit 140A, 140B includes its own dedicated skin 270. In alternative examples, a single skin 270 can cover both portions. In such an example, the skin 270 is removably mounted to the frame 142, and is removed before the doors are opened.

During operation of the vehicle 100, each portion of the split refrigeration unit 140A, 140B provides cooling to the trailer 130. In some examples, the portions of the split refrigeration unit 140A, 140B are sized such that each unit 140A, 140B provides approximately half of the necessary cooling, and each portion of the split refrigeration unit 140A, 140B operates in conjunction with the other portion to provide full cooling. In alternative examples, each portion of the split refrigeration unit 140A, 140B is sized to provide sufficient refrigeration to refrigerate the trailer 130 without the assistance of the other portion of the split refrigeration unit 140A, 140B. In such examples, a first split refrigeration unit 140A operates in a refrigerating cycle discharging power from the corresponding electrical storage unit 240. Simultaneously, the second portion of the split refrigeration unit 140B operates in a charging cycle, utilizing electrical power from the tractor 120 to charge the electrical storage unit 240. When the electrical storage unit 240 of the first split refrigeration unit 140A falls below a threshold charge level, the first refrigeration transitions to a charging function, and signals the second refrigeration unit 140B to begin a refrigeration cycle. In another example, each unit 140A, 140B is in direct electrical communication with the tractor's power system (i.e. tractor battery or tractor energy storage) and the electrical storage unit 240 is omitted.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1. A split trailer refrigeration unit for a tractor trailer comprising:
a first portion including an electrically driven compressor, a condenser and an evaporator;
a second portion, the second portion including an electrically driven compressor, a condenser and an evaporator;
at least one of the first portion and the second portion including a set of power electronics connecting an electricity source to the corresponding electric compressor, the set of power electronics being configured to control power characteristics of power provided from the electricity source to the electric compressor; and
a frame configured to structurally mount each of the first portion and the second portion to a rear trailer door.

2. The split trailer refrigeration unit of claim 1, wherein the electricity source is at least one of an electrical storage unit and a power interface connected to an external power source.

3. The split trailer refrigeration unit of claim 2, wherein the electricity source includes both the electrical storage unit and the power interface connected to the external power source.

4. The split refrigeration unit of claim 1, wherein the frame is integral to a trailer door and wherein a trailer door latch is a component of the frame.

5. The split refrigeration unit of claim 1, wherein the frame is mountable to a trailer door and distinct from the trailer door.

6. The split refrigeration unit of claim 1, wherein each of said first portion and said second portion is sized to independently refrigerate a trailer.

7. The split refrigeration unit of claim 6, further comprising a controller configured to operate the first portion in an electrical storage unit charging operation and the second portion in a refrigeration operation during a first mode, and configured to operate the second portion in the electrical storage unit charging operation and the first portion in the refrigeration operation during a second mode.

8. The split refrigeration unit of claim 7, wherein the controller is configured to transition from the first mode to the second mode in response to the electrical storage unit in the second portion falling below a charge threshold.

9. The split refrigeration unit of claim 1, wherein each of the first and second portion are sized to provide less than full refrigeration of the trailer.

10. The split refrigeration unit of claim 1, further comprising an external skin covering at least one of the first portion and the second portion.

11. The split refrigeration unit of claim 10, wherein the external skin comprises a first aerodynamic component covering the first portion and a second aerodynamic component covering the second portion.

12. The split refrigeration unit of claim 10, wherein the external skin has an aerodynamic profile including one of an angular planar configuration, hemispherical curved configuration and a teardrop configuration.

13. A method for refrigerating a tractor trailer comprising:
powering at least one portion of a rear mounted refrigeration unit via an electrical power source and operating the at least one portion of a rear mounted refrigeration unit in a refrigeration mode.

14. The method of claim 13, wherein powering the at least one portion of the rear mounted refrigeration unit via the electrical power source comprises simultaneously powering a first portion and a second portion of the rear mounted refrigeration unit via the electrical power source, wherein each of the first portion and the second portion are substantially identical.

15. The method of claim 14, wherein each of the first portion and the second portion are sized such that the first and second portion are insufficiently to independently cool the tractor trailer.

16. The method of claim 13, wherein powering the at least one portion of the rear mounted refrigeration unit comprises providing power to a first portion of the at least one portion during a first mode of operations and charging an electrical storage unit of a second portion of the at least one portion during the first mode of operations.

17. The method of claim 16, further comprising providing power to the second portion of the at least one portion during a second mode of operations and charging an electrical storage unit of the first portion of the at least one portion during the second mode of operations.

18. The method of claim 17, further comprising transitioning from the first mode of operations to the second mode of operations, in response to an electrical storage unit in the first portion falling below a threshold charge level.

19. A tractor trailer vehicle comprising:
a tractor including a plurality of fairings extending rearward from a rear end of the tractor;
a trailer connected to the tractor, wherein a gap between the rear end of the tractor and a forward end of the trailer is less than 43 inches; and
a rear mounted refrigeration unit connected to a rear end of the trailer via a frame, wherein the rear mounted refrigeration unit comprises
a first portion including an electrically driven compressor, a condenser and an evaporator;
a second portion, the second portion including an electrically driven compressor, a condenser and an evaporator; and
at least one of the first portion and the second portion including a set of power electronics connecting an electricity source to the corresponding electric compressor, the set of power electronics being configured to control power characteristics of power provided from the electricity source to the electric compressor.

20. The tractor trailer vehicle of claim 19, further comprising an aerodynamic external skin covering at least one of the first portion and the second portion.
